(19) United States
(12) Patent Application Publication
(10) Pub. No.: US 2012/0167051 A1
(43) Pub. Date: Jun. 28, 2012

(54) ELECTRONIC DEVICE AND METHOD FOR PROGRAM STRUCTURE ANALYSIS

(75) Inventors: YAO-HUA LIU, Shenzhen City (CN); XIN LU, Shenzhen City (CN); SHIH-FANG WONG, Tu-Cheng (TW); CHAO YANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/151,283

(22) Filed: Jun. 2, 2011

(30) Foreign Application Priority Data
Dec. 27, 2010 (CN) 201010607375.6

(51) Int. Cl. G06F 9/44

(52) U.S. Cl. 717/125

(57) ABSTRACT

An electronic device for program structure analysis is provided. The electronic device stores at least one program. The electronic device obtains one program from the data storage in response to user input and extracts structure identifiers of the program. After the identifiers of the program are obtained, the electronic device analyzes the obtained structure identifiers according to a predetermined rule to obtain a structure of the program. The structure of the program can be displayed using a table, web, or help file.

### BACKGROUND

1. Technical Field

The present disclosure relates to an electronic device and method for program structure analysis.

2. Description of Related Art

During software development, many programmers may need to cooperate with each other. In order to ensure that separately developed function modules written by the programmers can work together, the programmers should spend a lot of time to discuss the program structure. Additionally, after the software project is finished, white-box testing is needed. Before white-box testing is implemented, the tester must preview the program and determine the program structure of the software project, namely, relations between the classes, methods, and members belonging to the program of the software project, which all results in low efficiency and mistake prone testing.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device in accordance with an exemplary embodiment.

FIG. 2 is a flowchart of a method for analyzing the program structure of a program in the electronic device of FIG. 1.

### DETAILED DESCRIPTION

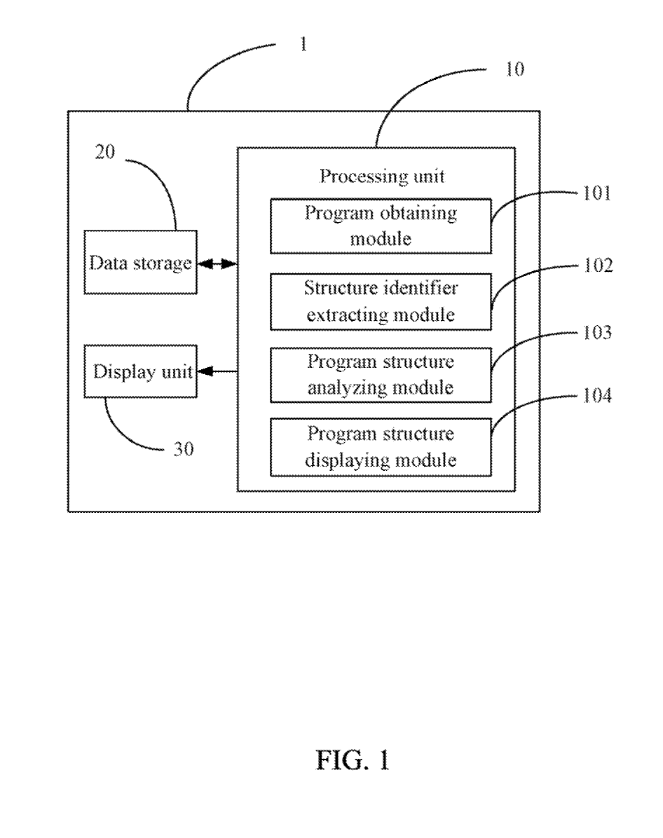

Referring to FIG. 1, an electronic device 1 of the present disclosure includes a processing unit 10, a data storage 20, and a display unit 30. The data storage 20 stores a plurality of programs (not shown). The processing unit 10 analyzes the programs stored in the data storage 20 to obtain program structures of the programs and displays the program structures of the programs on the display unit 30.

The processing unit 10 includes a program obtaining module 101, a structure identifier extracting module 102, a program structure analyzing module 103, and a program structure displaying module 104. The program obtaining module 101 is for obtaining the programs to be analyzed from the data storage 20 in response to user input. The structure identifier extracting module 102 is for extracting structure identifiers of the programs. Generally, the program includes modules, a head file, and comments. The modules can be classes, methods, and members. The header file commonly contains declarations of the modules. The comments are used for illustrating the modules. Thereby, the structure identifier in the exemplary embodiment can be the module names, the header file, and the comments. After the structure identifiers are obtained, the program structure analyzing module 103 analyzes the structure identifiers to obtain the structure of the program according to a predetermined rule and links the module name to a corresponding module of the program. The program structure describes the relationships of the modules, such as inheritance, polymorphism, or calling.

For example, if the class name of a class includes “:”, it can be concluded that the class inherits from a parent class. The predetermined rule is used by the programmers of the program. The program structure displaying module 104 displays the program structure of the program on the display unit 30 using a table, a webpage, or help files. Thus the user can obtain the program structure by accessing the table, webpage, or help files from the data storage 20 at any time and can obtain modules, such as the classes, methods, or members, by clicking corresponding module names.

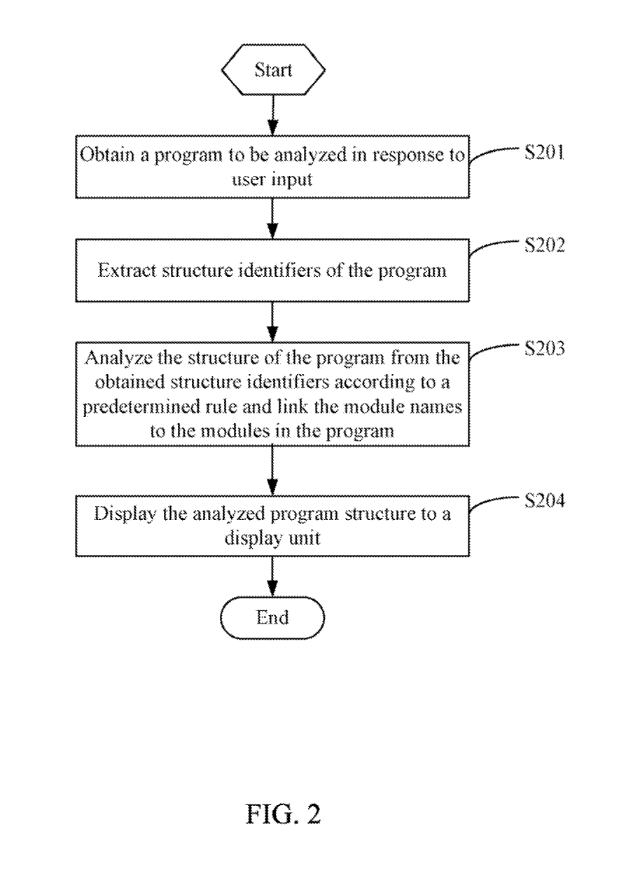

FIG. 2 is a flowchart of a method for analyzing the program structure of the program applied to the electronic device 1 of FIG. 1.

In step S201, the program obtaining module 101 obtains a program from the data storage 20 in response to user input.

In step S202, the structure identifier extracting module 102 extracts structure identifiers of the program.

In step S203, the program structure analyzing module 103 analyzes the obtained structure identifiers according to a predetermined rule to obtain the structure of the program and links module names to modules in the program.

In step S204, the program structure displaying module 104 displays the program structure on the display unit 30 using a table, a webpage, or help files.

Although, the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device for program structure analysis, comprising:
a data storage for storing one or more programs;
a display unit;
a program obtaining module for obtaining a program from the data storage in response to user input;
a structure identifier extracting module for extracting structure identifiers of the program;
a program structure analyzing module for analyzing the obtained structure identifiers according to a predetermined rule to obtain the structure of the program; and
a program structure displaying module for displaying the program structure on the display unit.

2. The electronic device as described in claim 1, wherein the program comprises modules, head files, comments, the header files contain declarations of modules, the comments are for illustrating the modules, the structure identifiers are names of the modules, the header files, and the comments.

3. The electronic device as described in claim 2, wherein program structure analyzing module further links the module names to the modules in the program.

4. The electronic device as described in claim 2, wherein the modules comprises classes, methods, and members.

5. The electronic device as described in claim 1, wherein the predetermined rule is a rule used by the programmers of the program.

6. The electronic device as described in claim 1, wherein the program structure displaying module displays the program structure on the display unit using a table, a webpage, or help files.

7. A method for analyzing program structure of a program applied to an electronic device, comprising:
obtaining a program to be analyzed in response to user input;
extracting structure identifiers of the obtained program;
analyzing the structure of the program from the obtained structure identifiers according to a predetermined rule to obtain the structure of the program; and
displaying the analyzed program structure of the program.

8. The method as described in claim 7, wherein the program comprises modules, head files, comments, the header files contain declarations of modules, the comments are for illustrating the modules, the structure identifier is names of the modules, the header files, and the comments.

9. The method as described in claim 7, further comprising linking the module names to the modules in the program after the structure of the program is analyzed.

10. The method as described in claim 7, wherein the modules comprise classes, methods, and members.

11. The method as described in claim 7, wherein the predetermined rule is a rule used by the programmers of the program.

12. The method as described in claim 7, wherein the program structure is displayed using a table, a webpage, or help files.
